(19) United States
(12) Patent Application Publication
(10) Pub. No.: US 2020/0302357 A1
(43) Pub. Date: Sep. 24, 2020

(54) SYSTEM AND METHOD FOR PROVIDING A MOBILITY NETWORK

(71) Applicant: Ford Global Technologies, LLC, Dearborn, MI (US)

(72) Inventors: David LONGIN, Herent (BE); Robin CELIS, Herent (BE); Detlef KUCK, Inden (DE); Lars KUHNERT, Koeln (DE); Mark GIJBELS, Binkom (BE)

(21) Appl. No.: 16/087,682

(22) PCT Filed: Aug. 31, 2016
(86) PCT No.: PCT/US2016/049632

§ 371 Date: Sep. 24, 2018

Related U.S. Application Data
(60) Provisional application No. 62/312,156, filed on Mar. 23, 2016.

(51) Int. Cl. G06Q 10/06; H04W 4/024; H04W 4/42; G06Q 10/08; G06Q 50/30; G06F 16/29; G01C 21/34; B62D 31/02

(52) U.S. Cl. CPC G06Q 10/06312; H04W 4/024; H04W 4/42; G06Q 10/08355; B62D 31/025; G06Q 10/06315; G06F 16/29; G01C 21/3415; G06Q 50/30

(57) ABSTRACT

A system for providing a mobility network is provided. The system is configured to receive a first request message transmitted from a first user device, the message indicating a pick-up location and a destination in a network area. The system is further configured to identify a first carrier unit available to respond to the first request message and generate a first response instruction providing data to indicate the pick-up location of the first request message. The system is further configured to transmit the first response instruction to the first carrier unit and generate path data and destination data according to the first response instruction and the first request message. The system is also configured to transmit the path data and the destination data to the first carrier unit and update the stored carrier unit operating conditions.

### CROSS-REFERENCE TO RELATED APPLICATIONS

This patent application claims priority to and all advantages of U.S. Provisional Patent Application No. 62/312,156, filed Mar. 24, 2016.

### BACKGROUND

Modern transportation systems, e.g. for urban areas and/or other relatively densely populated areas such as campuses, are designed towards providing quick and convenient service while minimizing environmental impact. However, current transport systems, including all required infrastructure, require large financial and spatial investment, and typically have limited flexibility with capacity, routes and schedules. A transportation system that provides on-demand service, in both schedule and/or routes, throughout a virtual route grid throughout, e.g., an urban area or campus, would be desirable, but currently difficult.

### DRAWINGS

FIG. 1 illustrates an example system for a mobility network including a remote computing system and multiple carrier units.

FIG. 2 illustrates an example automatically guided movement module.

FIG. 3 illustrates an example carrier unit including a passenger carrier platform.

FIG. 4 is a diagram of an example process for controlling one or more carrier units in a mobility network according to the principles of the present disclosure.

FIG. 5 is a diagram of an example process for maintaining one or more carrier units in a mobility network according to the principles of the present disclosure.

FIG. 6 is a diagram of an example process for operating one or more carrier units in a mobility network according to the principles of the present disclosure.

FIG. 7 is a diagram of an example process for partially controlling a sub-group of carrier units in a mobility network according to the principles of the present disclosure.

FIG. 8 is a diagram of an example process for partially operating a carrier unit as a part of a sub-group of carrier units in a mobility network according to the principles of the present disclosure.

FIG. 9 is a diagram of an example process for partially operating a carrier unit in cooperation with one or more other carrier units in a mobility network according to the principles of the present disclosure.

### DETAILED DESCRIPTION

### Overview

The present disclosure is directed to a system and method that provides for a mobility network with on-demand service capability, in both schedule and/or routes, throughout a virtual route grid. According to the principles of the present disclosure, an exemplary automatically guided movement (AGM) module is an assembly of sensing, computing and locating components configured for connectivity to the infrastructure of a variety of carrier units, e.g. carrier devices and carrier vehicles. According to the present disclosure, such exemplary carrier units include passenger carriers including a cabin and a passenger carrier platform. The passenger carrier platform includes an AGM module together with a standardized chassis and electric driveline, while defining a common cabin footprint, configured to support a wide variety of cabins, as may be customized for various passengers, service providers, other individual or institutional users.

In a mobility network according to the principles of the present disclosure, a computing device such as a server includes a processor and a memory in which data corresponding to a network area, such as relatively dense urban area of, e.g., predefined route segments between connection nodes, is defined and/or stored. The server is in communication with one or more carrier units, and/or one or more fleets of carrier units, via a communication network and the AGM modules. The server includes instructions executable to manage the traffic flow of the one or more carrier units and the one or more fleets, including determining requested routes from passengers or other users, monitoring power consumption and controlling the charging of carrier units. The server may interface with user devices for both individual and institutional users.

### System Elements

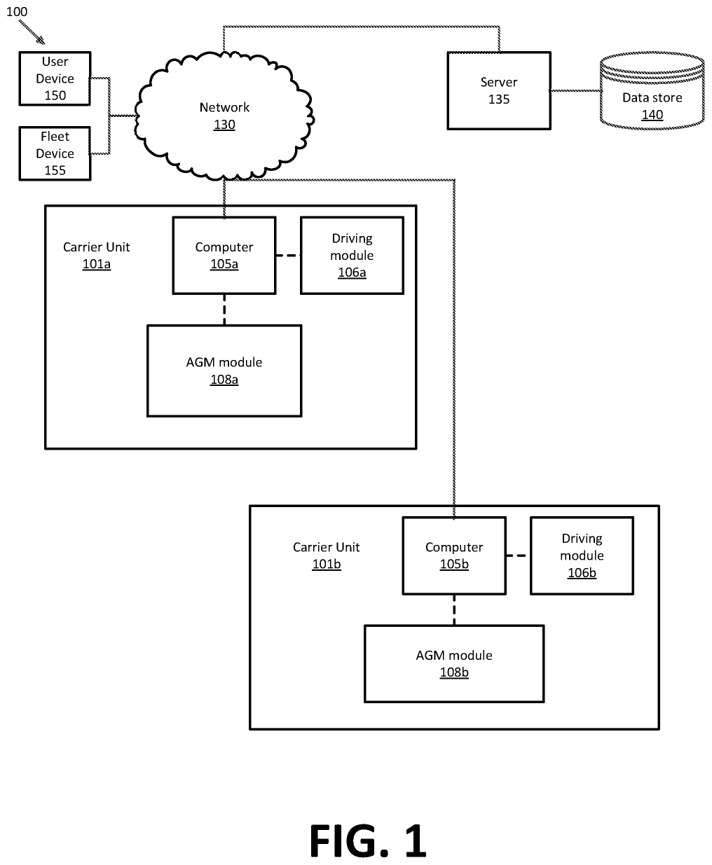

FIG. 1 is a block diagram of an example system 100 for providing a mobility network including a remote computing system and multiple carrier units. The disclosed subject matter may be applicable in a variety of setting and environments, e.g. an urban community, an airport, a theme park, a hospital, a college campus, etc. Likewise, the disclosed subject matter could be practiced in the context of many types of users, carrier units, vehicles, and/or other elements. As such, the particular system elements and implementations described in the examples herein should be understood to be exemplary.

Carrier units 101a, 101b respectively include carrier computers 105a, 105b; driving modules 106a, 106b; and AGM modules 108a, 108b. The AGM modules 108a, 108b respectively include AGM computers 109a, 109b; global positioning system (GPS) sensors 110a, 110b; and a variety of supplemental sensors 120a, 120b, such as RADAR sensors 122a, 122b and cameras 124a, 124b.

The carrier units 101a, 101b are in communication, via a network 130, with a server 135. The network 130 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 135 is in communication with a data store 140. The server 135 generally includes a processor and a memory, the memory including one or more forms of computer-readable media, and storing instructions executable by the processor for performing various operations, including as disclosed herein. The server 135 may be remotely located relative to carrier units/vehicles 101a and 101b, and may be in cloud-based communication with carrier units/vehicles 101a and 101b. The server 135 may store, e.g. in the data store 140, by way of non-limiting examples, data corresponding to a network area, predefined route segments between defined connection nodes in the network area, map and topography data of the mobility network area, traffic speed and density data, user demand data, and carrier unit characteristics, such as carrier unit charge and power consumption data, and carrier unit charging protocols.

The exemplary network 130 is further communicatively coupled to one or more user devices, e.g. individual user devices 150 and/or fleet devices 155. An individual user device 150 may be any one of a variety of computing devices including a processor and a memory, as well as communication capabilities. For example, the individual user device 150 may be a portable computer, tablet computer, a smart phone, etc. that includes capabilities for wireless communications using, e.g., IEEE 802.11, Bluetooth, and/or cellular communications protocols. In particular, the individual user device 150 may use such communications capabilities to communicate via the network 130. In operation, the individual user devices 150 provide at least indirect interfaces between individuals and carrier units 101a, 101b, e.g., passengers, potential passengers, and passenger vehicles.

The fleet device 155 may also be any one of a variety of computing devices including a processor and a memory, as well as communication capabilities, including wireless communications using, e.g., IEEE 802.11, Bluetooth, and/or cellular communications protocols. In operation, the fleet devices 155 provide at least indirect interfaces between a sub-operator of one or more carrier units. For example, in some embodiments, an institution, e.g. business or municipal, user has a dedicated a group of carrier units in the system 100 to provide delivery services, and the fleet device 155 is a dedicated computing device to provide an interface between the business user and their respective set of dedicated carrier units.

The system 100 operates to enable relatively efficient—in terms of speed, power consumption, use of carrier unit, etc.—transportation of passenger and/or goods throughout the network area via, e.g., predefined, determined and/or sensed route segments. In some embodiments, the server 135 generates on-demand routes through the network area, and generates models, from information from one or more carrier units over time, identifying conditions where demand for one or more particular carrier units may increase—e.g. typical commuting times, event locations, other transportation centers such as train stations, etc. Carrier units 101a and/or 101b query the server 135 for an on-demand route to a particular destination within the network area—e.g. a route of predefined route segments—and transmit data from, e.g., sensors, indicating any obstructions, traffic, within the network area, such as along a route of predefined route segments, along with status data, such as speed, power consumption, stored carrier unit characteristics such as type of carrier unit, etc. Individuals may, through one of the individual user devices 150, query the server 135 for the availability of a particular carrier unit 101a, 101b. Respective availabilities of carrier units according to the principle of the present disclosure depend on, by non-limiting example, operating conditions (e.g. whether a particular unit is in use and, if so, where is the destination and when will it complete the task), power level, stored carrier unit characteristics (e.g. type of unit, maximum capacity, etc.), and current unit location and time to arrive to pick-up location. Institutional users may, through one of the fleet devices 155, manage a particular set or subset of carrier units. For example, a retail business may have a fleet of automated package delivery devices, e.g. self-driving suitcases that may deliver goods purchased by an individual to the individual or to a particular passenger carrier unit in which the individual will further travel. In another example, a corporate or municipal entity may have a fleet of commuter carrier units for their employees. Such targeted carrier units are identified as such in stored character unit characteristics in the data store 140.

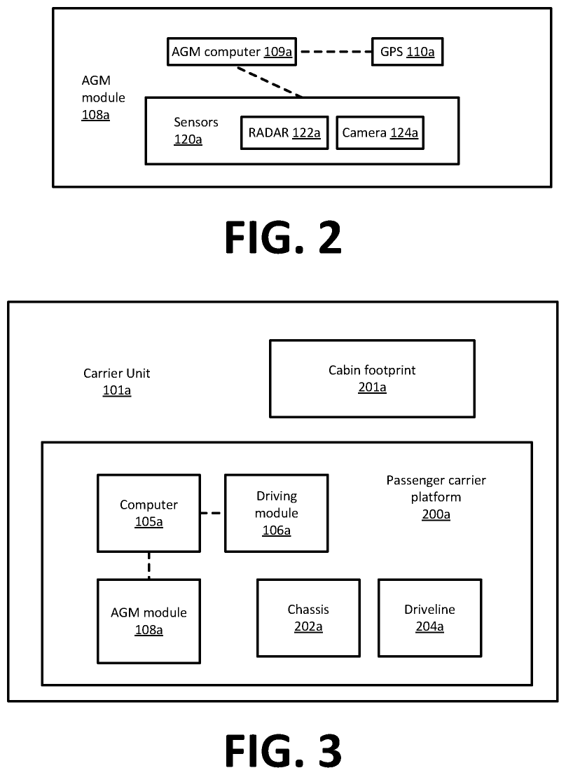

It should be understood that descriptions herein of one of carrier units 101a, 101b, and/or one of the AGM modules 108a, 108b, or any of the components thereof, are applicable to the other, respectively, and, thus, are not necessarily repeated herein for all counterpart components. In particular, unless otherwise noted herein, the description of AGM module 108a, and the components thereof (e.g. computer 109a) and, e.g., FIG. 2, are applicable to AGM module 108b and the respective components thereof. Additionally, unless otherwise noted herein, the description of carrier unit 101a, and the components thereof (e.g. cabin footprint 201a) and, e.g., FIG. 3, are applicable to carrier unit 101b and the respective components thereof. Furthermore, unless noted otherwise herein, operations of each vehicle 101a are similar to those of the vehicle 101b.

The computer 105a for the carrier unit 101a generally includes a processor and a memory, the memory including one or more forms of computer-readable media, and storing instructions executable by the processor for performing various operations, including as disclosed herein. The memory of the computer 105a also generally receives and stores data from sensors of the carrier unit 101a, such as imaging sensors, environmental sensors, system sensors, etc. In addition, the memory of the computer 105a may store various data, including data relating to a vehicle 101a location provided by the GPS 110a of the AGM module 108a, and other data collected from vehicle 101a controllers, sensors, etc.

Accordingly, the computer 105a is generally configured for communications on a bus such as an Ethernet bus, a controller area network (CAN) bus or any other suitable in-vehicle communications bus such as JASPAR, LIN, SAE J1850, AUTOSAR, MOST, etc., and/or may use other wired or wireless protocols, e.g., Bluetooth, etc. That is, the computer 105a can communicate via various mechanisms that may be provided in the carrier unit 101a and/or other devices such as one of the individual user devices 150.

Via the Ethernet bus, CAN bus, and/or other wired or wireless mechanisms, the computer 105a may transmit messages to various devices in the carrier unit 101a and/or receive messages from the various devices, e.g., controllers, actuators, sensors, etc. In addition, the computer 105a may be configured for communicating, e.g., with one or more remote servers 135, e.g., via the network 130, which, as described below, may include various wired and/or wireless networking technologies, e.g., cellular, Bluetooth, wired and/or wireless packet networks, etc.

Generally included in instructions stored in and executed by the computer 105a is a driving module 106a. Using data received in the computer 105a, e.g., from various sensors, from a communications bus, from the server 135, etc., the driving module 106a may control various components and/or operations of the carrier unit 101a. For example, the driving module 106a may be used to regulate speed, acceleration, deceleration, steering, gear shifts, operation of components such as lights, windshield wipers, etc. of the carrier unit 101a.

### AGM Module

Referring to FIG. 2, the AGM module 108a includes the AGM computer 109a, the GPS sensor 110a, and a variety of supplemental sensors 120a, including the RADAR sensor 122a and the cameras 124a.

The computer 109a for the AGM module generally includes a processor and a memory, the memory including one or more forms of computer-readable media, and storing instructions executable by the processor for performing various operations, including as disclosed herein. The memory of the computer 109a also generally receives and stores data from sensors 120a. In addition, the memory of the computer 109a may store various data, including data relating to a location provided by the GPS 110a, and other data collected from controllers, sensors, etc.

Accordingly, the computer 109a is generally configured for communications on a bus such as an Ethernet bus, a controller area network (CAN) bus or any other suitable in-vehicle communications bus such as JASPAR, LIN, SAE J1850, AUTOSAR, MOST, etc., and/or may use other wired or wireless protocols, e.g., Bluetooth, etc. That is, the computer 109a can communicate via various mechanisms that may be provided in the carrier unit 101a and/or other devices such as one of the individual user devices 150. The computer 109a is configured to communicate through the network 130 with the server 135 and with other AGM modules, e.g. the computer 109b. The computer 109a may also communicate with other computing devices, e.g. user devices 150, fleet devices 155, computing devices for managing other, complementary transportation (such as trains) in communication over the network 130, computing devices identifying a large number of potential users in a particular area (such as by mobile phone or other device location data).

The navigation system, e.g., GPS 110a, is operable to determine geo-coordinates, i.e., latitude and longitude, of the carrier unit 101a. GPS 110a may also receive input, e.g., geo-coordinates, a street address or the like, etc. of a location of a target destination of the carrier unit 101a. Such input may additionally be provided to, e.g., the computer 109a from one of the individual user devices 150 therein or remotely, e.g., via the network 130. Further, the server 135 may use information from the GPS 110a and/or an individual user device 150 to generate a route to be followed to an intended destination.

A variety of sensors 120a and other sources provide data for the AGM module 108a. Sensors 120a may include mechanisms such as RADAR 122, cameras 124, or the like, e.g., LIDAR, sonar, a breathalyzer, motion detectors, etc. In addition, sensors 120a could include devices operable to detect a position, change in position, rate of change in position, etc., of carrier unit 101a components such as a steering wheel, brake pedal, accelerator, gearshift lever, etc. The sensors 120a may measure values relating to operation of the carrier unit 101a and of the surrounding vehicles and environment. For example, the sensors 120a may measure the speed and location of the carrier unit 101a, a speed and location of surrounding vehicles relative to the vehicle 101a, and/or values that may impact performance such as altitude, speed, fuel volume, acceleration, temperature, topography, etc.

### Passenger Carrier Platform

Referring to FIG. 3, the carrier unit 101a may, in some embodiments, further comprise a passenger carrier platform 200a. The passenger carrier platform 200a may be optimized for cost and safety and, thus, may be relatively small, light, slow, and have a relatively shorter range of operation in comparison to typical mass market passenger vehicles. The carrier platform 200a defines a cabin footprint 201a and is configured to support a variety of cabin components within certain design thresholds, e.g. weight, size, safety performance. In some embodiments, for example, the passenger carrier platform 200a may have a B-car like footprint, which generally includes space for up to 4 passenger seats.

The passenger carrier platform 200a according to the principles of the present disclosure includes the AGM module 108a together with the computer 105a, a chassis 202a, and a driveline 204a. In some embodiments, the driveline 204a is electric and includes batteries which may be swapped and/or inductively charged. In such embodiments, the driveline 204a is configured to provide the carrier unit 101a with a maximum speed of approximately 25 km/h, and a range of approximately 50 km, each ultimately depending on the particular passenger cabin, the passengers and any cargo, the driving conditions, etc. In some embodiments, the carrier unit 101a may be configured to meet certain vehicle efficiency standards, e.g. L7e vehicle class homologation.

In some embodiments, the passenger carrier platform 200a may be configured to accept both automated and manual steering controls, and may be configured to incorporate OEM components from existing mass-market passenger vehicles (e.g. sensors, chassis components, brakes, driveline components, etc.).

With the passenger carrier platform 200a including, e.g., the AGM module 108a, the computer 105a, and the driveline 204a, the carrier unit 101a may be customized with a wide variety of cabins, while being fully configured for operation within the system 100. That is, with the fundamental operational and control components for the carrier unit 101a incorporated into the passenger carrier platform 200a, the cabin of the carrier unit 101a may be configured as desired for a user, e.g. an institutional user—from a mobile kiosk to a mobile workstation for commuters—with connectivity and compatibility with the system 100 provided through the carrier platform 200a.

### Example Processes

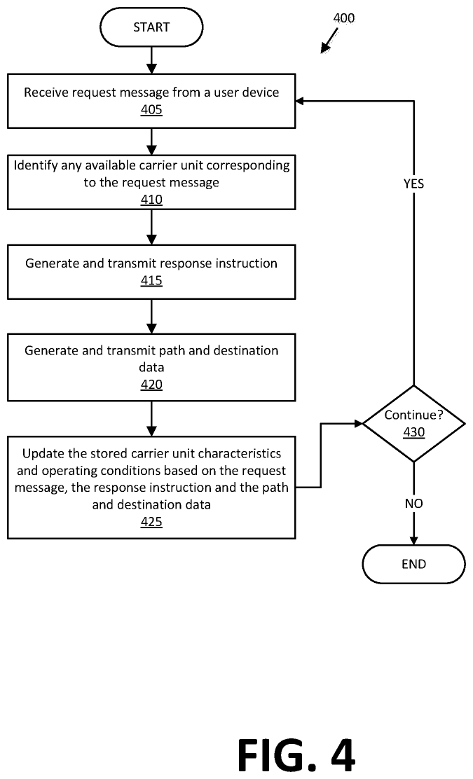

FIG. 4 is a diagram of an example process 400 for controlling one or more carrier units in a mobility network according to the principles of the present disclosure.

The process 400 begins in a block 405 in which the server 135 receives a request message via the network 130 from a user device, e.g., an individual user device 150 and/or a fleet device 155. The request message may be received via the network 130 in a known manner. The request message typically includes data identifying desired pickup and/or drop off locations, i.e. destination, and/or desired characteristics for a passenger and/or a delivery, as well as data identifying the desired number and nature of the passengers and/or cargo to be transported, e.g., regarding the nature of passengers, commuting passengers, shopping passengers, etc. For example, the request message may identify a group of shoppers at a retail location desiring to be transported home, together with merchandise purchased at the retail location. In another example, the request message may identify a group of employees desiring to commute home from their place of employment.

Next, in a block 410, the server 135 identifies a carrier unit available to operate according to at least the request message, corresponding desired carrier unit characteristics, and stored carrier unit characteristics. If there are multiple available carrier units providing responsive functionality, the server 135 identifies the carrier unit which may most efficiently satisfy the request message, e.g., the closest carrier unit by travel time while satisfying the desired carrier unit characteristics. For example, the server 135 compares the data in the request message to received and/or stored carrier unit characteristics and operating conditions stored in the data store 140. If so, in a block 415, the server 135 generates a response instruction to an available corresponding carrier unit, the response instruction including data to direct the available corresponding carrier unit to travel to the pickup location in the request message. Next, in a block 420, the server 135 generates path data made up of, e.g., predetermined route segments stored on the data store 140, and transmits data identifying the path data and the destination data to the available corresponding carrier unit. The server 135 may determine the path data based on distance, speed, traffic models, sensed and/or received traffic data (e.g. from carrier units 101), sensed and/or received environmental conditions, sensed and/or received obstruction data, etc. For example, for users desiring to return home from a particular retail location, the server 135 may generate different paths and, correspondingly different path data, based on expected commuter traffic and/or sensed environmental conditions and/or traffic conditions.

Next, in a block 425, the server 135 may update the stored carrier unit characteristics and operating conditions based on the request message, the response instruction and the path data and the destination data.

Next, in the block 430, the server 135 determines whether the process 400 should continue. For example, the process 400 may end if the server 135 determines that no request messages are expected to be received for a certain amount of time. In any case, if the process 400 should not continue the process 400 ends following the block 430. Otherwise, the process 400 returns to the block 405.

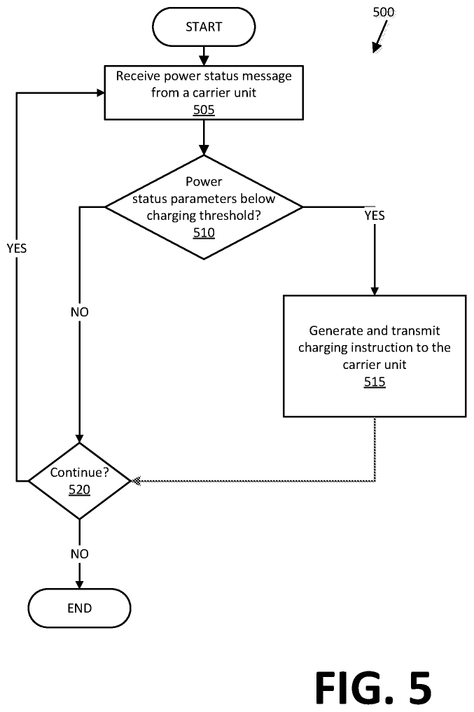

FIG. 5 is a diagram of an example process 500 for maintaining one or more carrier units in a mobility network according to the principles of the present disclosure.

The process 500 begins in a block 505 in which the server 135 receives a power status message via the network 130 from a carrier unit 101a. Based on the data of the status message, the server 135 identifies and/or updates the power status parameters corresponding to the carrier unit 101a. The power status message may be received via the network 130 in a known manner. For example, the computer 105a of the carrier unit 101a may generate and transmit, via the network 130, the power status message for the carrier unit 101a, including data identifying the charge state of the power supply, e.g. batteries, of the carrier unit 101a.

Next, in a block 510, the server 135 determines whether the power status parameters for the carrier unit 101a are below a charging threshold stored in the data store 140. If so, in a block 515, the server 135 generates and transmits a charging instruction to the carrier unit 101a. For example, the charging instruction includes data to direct the carrier unit 101a to travel to a charging station location in the network area, stored in the data store 140, and data identifying a charging operation, stored in the data store 140, suitable for the carrier unit 101a at the identified charging station location.

Next, the process 500 continues to a block 520. The process also continues to the block 520 if, at the block 510, the power status parameters for the carrier unit 101a meet or exceed the charging threshold in the data store 140. At the block 520, the server 135 determines whether the process 500 should continue. For example, the process 500 may end if the server 135 determines that no carrier units are expected to require charging for a certain amount of time. In any case, if the process 500 should not continue, the process 500 ends following the block 520. Otherwise, the process 500 returns to the block 505.

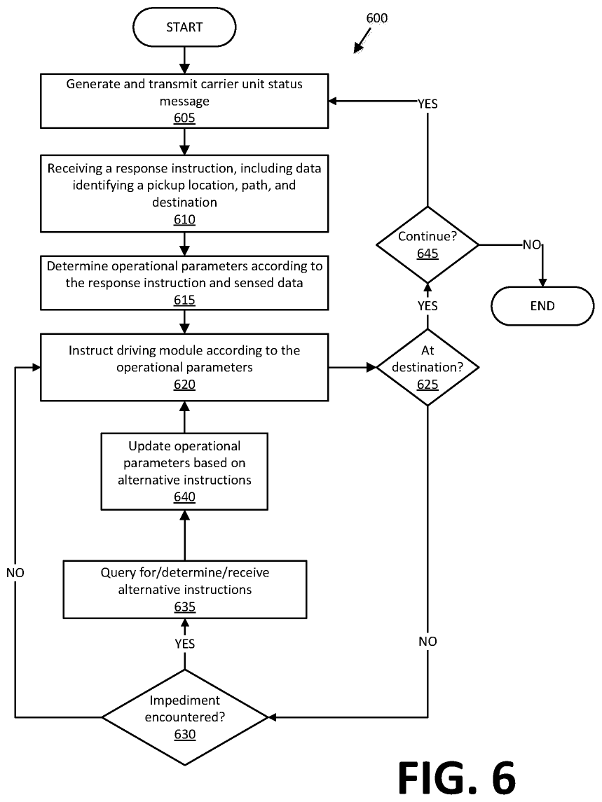

FIG. 6 is a diagram of an example process 600 for operating one or more carrier units in a mobility network according to the principles of the present disclosure.

The process 600 begins in a block 605 in which a carrier unit, e.g. the carrier unit 101a, generates and transmits, e.g. through the computer 105a and/or the AGM module 108a, a carrier unit status message via the network 130 to the server 135. For example, the carrier unit status message may include data corresponding the power status message for the carrier unit 101a, i.e. data identifying the charge state of the power supply, e.g. batteries, of the carrier unit 101a. The carrier unit status message may also include data identifying the location of the carrier unit 101a, the type of the carrier unit 101a.

Next, in a block 610, the carrier unit 101a receives a response instruction, including data identifying a pickup location, destination, and path, all within the network area, as disclosed herein with respect to the process 400, from the server 135 via the network 130. Next, in a block 615, the carrier unit 101a, e.g. through the computer 105a and/or the AGM module 108a, determines operational parameters according to the response instruction and sensed data, e.g. environmental conditions around the carrier unit 101a. Next, in a block 620, the driving module 106 is instructed and operated according to the operational parameters.

Referring to blocks 625-630, if the carrier unit 101a has not reached the destination, but detects and/or determines an obstacle is present in the path identified by the path data in the response instruction, then, at a block 635, the carrier unit 101a, e.g. through the computer 105a and/or the AGM module 108a, queries the server 135, through the network 130, for alternate instructions. For example, the path may be obstructed by unexpected congestion, and the server 135 may transmit different path data, identifying an alternate path among, e.g., predetermined route segments or other stored travel ways. In another example, the carrier unit 101a and the server 135 may be unable to identify an obstruction. The server 135 may provide instructions generated in real time by a manual administrator, to guide the carrier unit 101a around the obstruction via, e.g., a view of the obstruction the camera 124a of the carrier unit 101a. The carrier unit 101a then, at a block 640, updates the operational parameters according to the alternative instructions, and the process 600 returns to the block 620, and the updated operational parameters are applied.

When the carrier unit 101a reaches the destination in the response instruction, the process 600 continues from the block 625 to a block 645, and the carrier unit 101a determines whether the process 600 should continue. For example, the process 600 may end if the carrier unit 101a determines that users are expected in a certain upcoming amount of time. In one such example, for carrier units that are for deliveries from retail store, the process 600 may end when the store closes. In any case, if the process 600 should not continue, the process 600 ends following the block 645. Otherwise, the process 600 returns to the block 605.

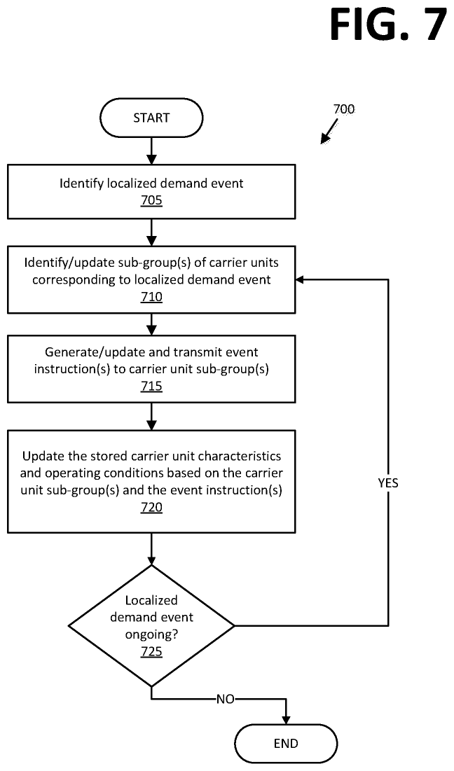

FIG. 7 is a diagram of an example process 700 for controlling a sub-group of carrier units in a mobility network according to the principles of the present disclosure.

The process 700 begins in a block 705 in which the server 135 identifies a localized demand event with the mobility network area. For example, the server 135 may model data in the data store 140 to map the time and location of commuting hubs in an urban environment. In another example, the server 135 may be in communication with a computing device with event information on a campus.

Next, in a block 710, the server 135 identifies a sub-group of carrier units available to respond to anticipated demand from the identified localized demand event. The number and identification of the sub-group depends on the characteristics of the carrier units (e.g. how many passengers can be accommodated), the level of demand, the travel time to the event area, etc., all which may be stored and updated as stored carrier unit characteristics in the data store 140. Next, in a block 715, the server 135 generates event instructions to the sub-group of carrier units. Event instructions may, for example, include data defining a sub-area in which the sub-groups of carrier units wait or circle until a particular request is received, or, in another example, include data identifying a particular pick-up path and protocol (such as at an airport). The server 135 may determine the event instructions based on distance, speed, traffic models, sensed and/or received traffic data (e.g. from carrier units 101), sensed and/or received environmental conditions, sensed and/or received obstruction data, etc.

Next, in a block 720, the server 135 may update the stored carrier unit characteristics and operating conditions based on the carrier unit sub-groups and the event instructions. For example, with a sub-group responding to the localized demand event, the population of available carrier units outside of that event area would be lowered.

Next, in the block 725, the server 135 determines whether the process 700 should continue, i.e. whether the localized demand event is ongoing. If the event is ongoing, the process returns to the block 170, and the sub-group may be updated—i.e. expanded if demand is increasing, or shrunk if demand is decreasing. When it is determined by the server 135 that the event is over, the process 700 ends following the block 725.

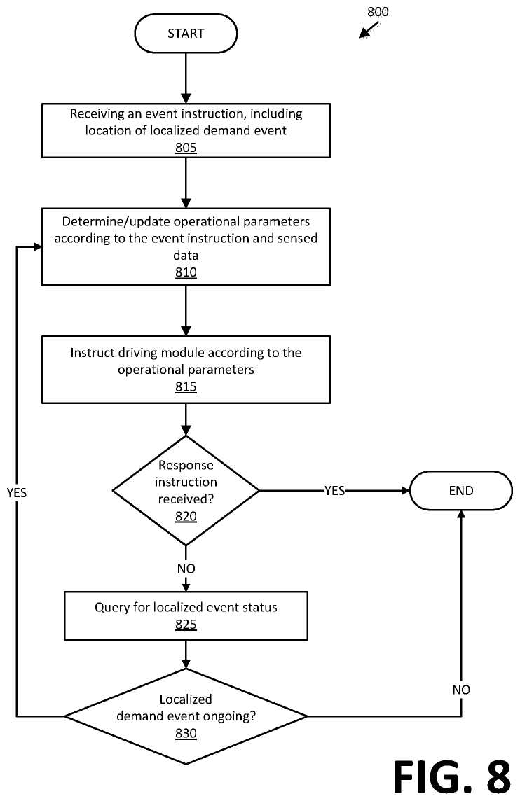

FIG. 8 is a diagram of an example process 800 for operating a carrier unit as a part of a sub-group of carrier units in a mobility network according to the principles of the present disclosure. It should be understood that a carrier unit according to the principles of the present instructions may continue to operate, outside or following the process 800, upon receipt of a response instruction, as disclosed herein.

The process 800 begins in a block 805 in which a carrier unit, e.g. the carrier unit 101a, receives an event instruction, including location of a localized demand event, as disclosed herein with respect to the process 700, from the server 135 via the network 130. Next, in a block 810, the carrier unit 101a, e.g. through the computer 105a and/or the AGM module 108a, determines operational parameters according to the event instruction and sensed data, e.g. environmental conditions around the carrier unit 101a. Next, in a block 815, the driving module 106 is instructed and operated according to the operational parameters.

Referring to a block 820, if a response instruction is received while operating the carrier unit 101a according to the event instruction, the process 800 ends, with the carrier unit 101a proceeding to operate according to that response instruction, as otherwise disclosed herein. If the carrier unit 101a has operated according to the event instructions for an instructed amount of time, or, otherwise, for a default period or according to some other default condition, all without receiving a request instruction for a particular user, then, at a block 825, the carrier unit 101a, e.g. through the computer 105a and/or the AGM module 108a, queries the server 135, through the network 130, for the localized event status. If, at a block 830, the event is no longer ongoing, the process 800 ends. Otherwise, the process 800 returns to the block 810.

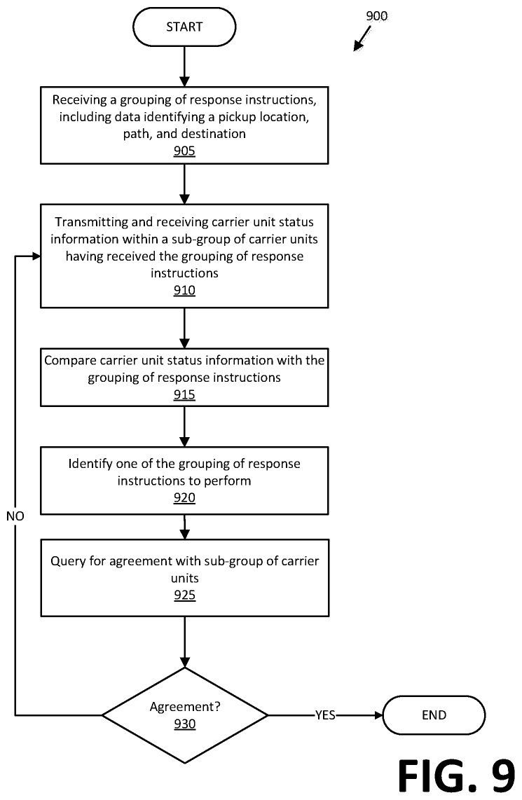

FIG. 9 is a diagram of an example process 900 for operating a carrier unit in cooperation with one or more other carrier units in a mobility network according to the principles of the present disclosure, in which the carrier units. It should be understood that a carrier unit according to the principles of the present instructions may continue to operate, outside or following cooperatively delegate the responses to a grouping of requests. the process 900, upon receipt of a response instruction, as disclosed herein.

The process 900 begins in a block 905 in which a carrier unit, e.g. the carrier unit 101a, receives a grouping of response instructions, each instruction including data identifying a pickup location, destination, and path, such as, e.g., disclosed herein with respect to the process 400, from the server 135 via the network 130. Next, in a block 910, the carrier unit 101a, e.g. through the computer 105a and/or the AGM module 108a, and the network 130, transmits and receives carrier unit status information within a sub-group of carrier units that each have received the grouping of response instructions. The sub-group may be defined by the server 135 by location of the carrier units, or in response to a localized demand event, such as discussed herein with respect to processes 700 and 800. Otherwise, the sub-group may be self-defined by nearby carrier units, or carrier units sharing particular features. For example, a grouping of response instructions may be for relatively large groups of users, respectively, which size groups only some of the carrier units may accommodate.

Next, in block 915, the carrier unit 101a, e.g. through the computer 105a and/or the AGM module 108a, compares the carrier unit status information from the sub-group and the grouping of response instructions and identifies a response instruction, or multiple instructions, that it is a candidate to satisfy. Then, at a block 920, the carrier unit 101a, e.g. through the computer 105a and/or the AGM module 108a, queries the sub-group as to whether there is agreement as to which of the response instructions it should operate. If there is agreement, the instruction is delegated and the process 900 ends, with the carrier unit 101a proceeding to operate according to the identified response instruction, as otherwise disclosed herein. If there is not an agreement, the process 900 returns to the block 910, towards ultimate delegation of all of the grouping of response instructions. For example, two carrier units in the sub-group may be closest to the same user, or group of users, among the grouping of response instructions. If other characteristics or sensed data do not differentiate the ability of these carrier units to perform, updating status information may identify another user to respond to, or other points of differentiation to identify the most efficient response to each of the grouping of response instructions.

### CONCLUSION

Computing devices such as those discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising:
a computer comprising a processor and a memory, the memory storing instructions executable by the processor to:
receive a first request message transmitted from a first user device, the first request message providing data to indicate a pick-up location and a destination in a network area stored in the memory;
identify a first carrier unit in the network area available to respond to the first request message based on the first request message and stored carrier unit operating conditions;
generate a first response instruction, the first response instruction providing data to indicate the pick-up location of the first request message;
transmit the first response instruction to the first carrier unit;
generate path data and destination data according to the first response instruction and the first request message, the path data identifying a route in the network area from the pick-up location to the destination, the destination data identifying the destination in the network area;
transmit the path data and the destination data to the first carrier unit; and
update the stored carrier unit operating conditions based on the first request message, the first response instruction, and the path data and the destination data.

2. The system of claim 1, wherein the memory stores further instructions executable by the processor to:
receive a second request message transmitted from a second user device, the second request message providing data to indicate a second pick-up location and a second destination in the network area stored in the memory; and
identify a second carrier unit in the network area available to respond to the second request message based on the second request message and stored carrier unit operating conditions.

3. The system of claim 1, wherein the memory stores further instructions executable by the processor to:
identify a second carrier unit in the network area available to respond to the first request message based on the first request message and stored carrier unit operating conditions; and
compare respective availabilities of the first and second carrier units; and
determine, according to at least the availabilities, one of the first and second carrier units to instruct to respond to the first request message.

4. The system of claim 1, wherein the first request message further provides data to indicate desired carrier unit characteristics.

5. The system of claim 4, wherein the identification of the first carrier unit in the network area available to respond to the first request message is further based on stored carrier unit characteristics.

6. The system of claim 1, wherein the memory stores further instructions executable by the processor to:
receive a query for alternate instructions based on a detected obstruction;
and
generate and transmit alternative instructions including data identifying an alternate path in the network area around the detected obstruction.

7. The system of claim 2, wherein the first and second carrier units have distinct carrier unit characteristics.

8. The system of claim 7, wherein the first and second carrier units include corresponding passenger carrier platforms and distinct passenger cabins, respectively.

9. The system of claim 7, wherein one of the first and second carrier units is a passenger carrier unit, and the other of the first and second carrier units is a package delivery device.

10. The system of claim 1, wherein the memory stores further instructions executable by the processor to:
identify a first sub-group of a plurality of carrier units, the first sub-group including the first carrier unit.

11. The system of claim 10, wherein the memory stores further instructions executable by the processor to:
identify localized demand event in the network area; and
generate and transmit event instructions to the first sub-group,
wherein identifying the first sub-group is based on carrier unit availability to respond to anticipated demand from the identified localized demand event.

12. The system of claim 10, wherein the memory stores further instructions executable by the processor to:
generate and transmit a grouping of response instructions to the first sub-group, the first sub-group being configured to delegate each of the grouping of response instructions to one of the carrier units of the first sub-group.

13. A method comprising:
receiving a first request message transmitted from a first user device, the first request message providing data to indicate a pick-up location and a destination in a network area stored in a memory of a computing device;
identifying a first carrier unit in the network area available to respond to the first request message based on the first request message and stored carrier unit operating conditions;
generating a first response instruction, the first response instruction providing data to indicate the pick-up location of the first request message;
transmitting the first response instruction to the first carrier unit;
generating path data and destination data according to the first response instruction and the first request message, the path data identifying a route in the network area from the pick-up location to the destination, the destination data identifying the destination in the network area;
transmitting the path data and the destination data to the first carrier unit; and
updating the stored carrier unit operating conditions based on the first request message, the first response instruction, and the path data and the destination data.

14. The method of claim 13, further comprising:
receiving a second request message transmitted from a second user device, the second request message providing data to indicate a second pick-up location and a second destination in the network area stored in the memory; and
identifying a second carrier unit in the network area available to respond to the second request message based on the second request message and stored carrier unit operating conditions.

15. The method of claim 13, further comprising:
identifying a second carrier unit in the network area available to respond to the first request message based on the first request message and stored carrier unit operating conditions;
comparing respective availabilities of the first and second carrier units; and
determining, according to at least the availabilities, one of the first and second carrier units to instruct to respond to the first request message.

16. The method of claim 13, wherein the first request message further provides data to indicate desired carrier unit characteristics.

17. The method of claim 16, wherein the identification of the first carrier unit in the network area available to respond to the first request message is further based on stored carrier unit characteristics.

18. The method of claim 13, further comprising:
receiving a query for alternate instructions based on a detected obstruction; and
generating and transmitting alternative instructions including data identifying an alternate path in the network area around the detected obstruction.

19. The method of claim 13, further comprising:
identifying a localized demand event in the network area;
identifying a first sub-group of a plurality of carrier units based on carrier unit availability to respond to anticipated demand from the identified localized demand event, the first sub-group including the first carrier unit; and
generating and transmitting event instructions to the first sub-group.

20. The method of claim 13, further comprising:
identifying a first sub-group of a plurality of carrier units, the first sub-group including the first carrier unit; and
generating and transmitting a grouping of response instructions to the first sub-group, the first sub-group being configured to delegate each of the grouping of response instructions to one of the carrier units of the first sub-group.
